(19) United States
(12) Patent Application Publication
(10) Pub. No.: US 2006/0256070 A1
(43) Pub. Date: Nov. 16, 2006

(54) Communications system including units with LCD optical transmitters/receivers and related methods

(75) Inventors: Vahid Moosavi, Kitchener (CA); Herbert A. Little, Waterloo (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Research In Motion Limited, Waterloo (CA)

(21) Appl. No.: 11/128,604

(22) Filed: May 13, 2005

(51) Int. Cl. G09G 3/36

(52) U.S. Cl. 345/104

(57) ABSTRACT

A communications system may include first and second separate units, at least one of which may include a radio frequency (RF) transceiver. The first unit may include a liquid crystal display (LCD) including at least one optical transmitter pixel. Further, the second wireless unit may include at least one optical receiver for receiving optical signals from the at least one optical transmitter pixel of the LCD.

### FIELD OF THE INVENTION

The present invention relates to the field of communications, and more particularly, to a communications system and method using optical communication.

### BACKGROUND OF THE INVENTION

Electronic computing devices, such as laptop computers and personal digital assistants (PDAs), allow for increased productivity as well as the ability to more easily transport and transmit data. For example, such devices may include wireless radio frequency (RF) transceivers which allow them to access the Internet and/or send electronic mail (email) messages over a cellular network or a wireless local area network (LAN).

Moreover, such devices may also communicate via wireless personal area networks (PANs), for example. PANs interconnect devices within the range of an individual person, typically within a range of about ten meters. For example, a person may wirelessly interconnect a laptop, a personal digital assistant (PDA), and a portable printer within a relatively close proximity of one another using a common wireless PAN communications protocol, such as the IEEE 802.15 standard.

In certain applications, it may be desirable for such devices to communicate by mediums other than wireless RF signals. For example, infrared and optical signals often provide for convenient wireless device communications at close range with devices that have a clear line of sight to one another. That is, infrared and/or optical communication may be less susceptible to RF interference, and the regulations governing short-range infrared/optical communications are generally less stringent than for RF communications.

One example of a portable device which uses an optical transmitter for short range communications is set forth in U.S. Patent Application Publication No. 2004/0005033 by Nishihara et al. The Nishihara et al. application discloses a cassette for use with a radiographic imaging system using a photo-stimulable media. The cassette includes an optical data transmitter adapted to send an optical output and a controller. The optical transmitter may be a liquid crystal display (LCD) or a light emitting diode(s) (LED), the output of which changes when so instructed by the controller. The cassette has a housing having the optical transmitter and controller, and the optical transmitter is positioned to be externally observable.

With the ease of data exchange provided by electronic computing devices having wireless communications capabilities, the challenge of protecting an organization's data can be difficult. Accordingly, in some applications it may be desirable to enhance security measures for using such electronic computing devices, while at the same time not stifling the increased productivity such devices can provide.

### BRIEF DESCRIPTION OF THE DRAWINGS

FIG. 1 is schematic block diagram of a communications system in accordance with the present invention.

FIG. 2 is schematic block diagram of an alternate embodiment of the communications system of FIG. 1.

FIG. 3 is a flow diagram of a communications method in accordance with the present invention.

FIG. 4 is a schematic block diagram illustrating exemplary components of a mobile wireless communications device in accordance with the present invention.

### DETAILED DESCRIPTION OF THE PREFERRED EMBODIMENTS

In view of the foregoing background, it is therefore an object of the present invention to provide a communications system with enhanced security and inter-unit communication features and related methods.

This and other objects, features, and advantages in accordance with the present invention are provided by a communications system which may include first and second separate units, at least one of which may include a radio frequency (RF) transceiver. The first unit may include a liquid crystal display (LCD) including at least one optical transmitter pixel. Further, the second wireless unit may include at least one optical receiver for receiving optical signals from the at least one optical transmitter pixel of the LCD.

By way of example, the first unit may be a wireless communications device (e.g., PDA, laptop, wireless email device, etc.) which may include an RF transceiver for accessing a communications network (e.g., a LAN or cellular network). To keep unauthorized users from accessing sensitive material on a network, or from sending emails from the first unit which include sensitive information, the second unit may be an authentication device which includes an identity reader (e.g., a card reader, fingerprint reader, keypad for entering an access code, etc.). As such, the second unit may be used to enable the first unit to communicate using its RF transceiver based upon a received unique identifier (UID).

Thus, the optical transmitter pixel(s) of the first unit may send a device identifier to the second unit using optical signals, and the second unit compares the device identifier and the UID received from the user via the identity reader with corresponding entries stored in a memory. If the device identifier and UID are validated, then the second unit enables the first unit to begin using its RF transceiver for sending emails, accessing a network, etc. By way of example, the authenticating device may also include an RF transceiver which wirelessly enables the RF transceiver of the first unit.

The at least one optical transmitter pixel may include a plurality thereof, and they may be different color optical transmitter pixels, for example. More particularly, the plurality of different color LCD transmitter pixels may comprise red, blue and green optical transmitter pixels. This advantageously allows a greater quantity of data to be sent from the first unit to the second unit as opposed to using a single color of light. Moreover, one or more of the optical transmitter pixels may transmit optical clock signals. Similarly, the optical receiver may advantageously comprise a plurality of different color optical receivers for respective different color optical transmitter pixels.

The LCD may have a refresh rate, and the optical transmitter pixel(s) may operate based upon the refresh rate. The optical receiver(s) may include at least one optical filter, for example. Furthermore, the RF transceiver may communicate using a wireless local or personal area network protocol. Also, the first unit may include a processor connected to the at least one optical transmitter pixel, and the first and second units may have respective portable housings.

A communications method aspect of the invention may include providing first and second separate units, such as those described briefly above, and transmitting optical signals from the at least one optical transmitter pixel of the first unit. The method may further include receiving the optical signals from the at least one optical transmitter pixel using at least one optical receiver on the second unit.

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

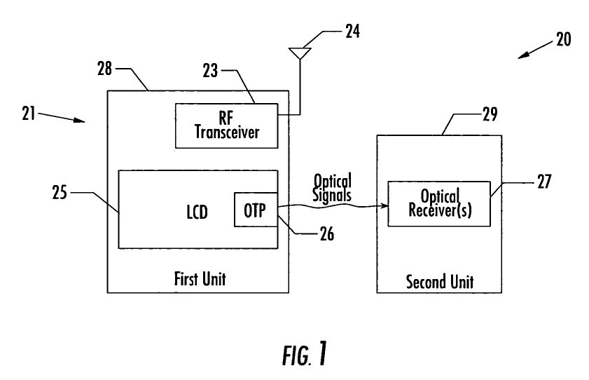

Referring initially to FIG. 1, a communications system 20 illustratively includes first and second separate units 21, 22. In the exemplary embodiment, the first unit 21 illustratively includes a radio frequency (RF) transceiver 23 and an accompanying antenna 24. By way of example, the RF transceiver 23 may communicate using a wireless LAN or wireless PAN protocol (e.g., Bluetooth, IEEE 802.11x or 802.15), or it may be a cellular transceiver for communicating via a cellular network. The RF transceiver 23 may also communicate based upon a Federal Information Processing Standard (FIPS) compliant encryption protocol, for example, as will be appreciated by those skilled in the art.

The first unit 21 also illustratively includes a liquid crystal display (LCD) 25 including one or more optical transmitter pixels (OTP) 26. Further, the second wireless unit 22 illustratively includes one or more optical receivers 27 for receiving optical signals from the optical transmitter pixel(s) 26 of the LCD 25. The respective components of the first and second units 21, 22 may be carried by respective portable housings 28, 29.

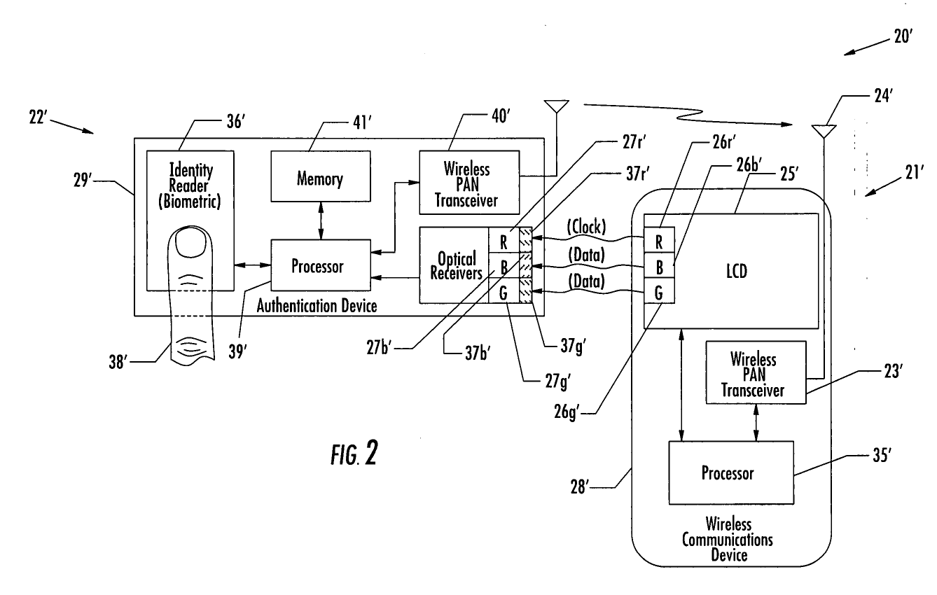

Turning additionally to FIG. 2, an embodiment of the invention in which the first unit 21′ is a wireless communications device and the second unit 22′ is an authentication device is now described. By way of example, the wireless communications device 21′ may be a PDA, laptop, wireless email device, etc., which allows a user to access files stored on a network or desktop computer by a wired and/or wireless communications link. The wireless communications device 21′ further illustratively includes a processor 35′ connected to the LCD 25′ and a wireless PAN transceiver 23′.

In the illustrated embodiment, a plurality of different color optical transmitters 26r′ (red), 26b′ (blue), and 26g′ (green) each including one or more pixels are used for transmitting optical clock and data signals. In the present example, the red optical transmitter 26r′ transmits a clock signal, while the blue and green optical transmitters 26b′, 26g′ transmit data signals. Of course, different signals may be transmitted using different color light in different embodiments, and colors other than those shown may be used as well. Using different colors for signal transmission advantageously allows a greater quantity of data to be sent from the wireless communications device 21′ to the authentication device 22′ as opposed to using a single color of light, although a single color may be used in certain embodiments as well.

To keep unauthorized users from accessing sensitive information, or sending emails from the wireless communications device 21′ which include sensitive information, for example, the authentication device 22′ may advantageously be used to verify that the wireless communications device is being used by the appropriate user, and then enable it for performing such tasks. To this end, the authentication device 22′ illustratively includes an identity reader 36′ for reading a unique identifier (UID) of the user. In the present example the identity reader 36′ is a fingerprint reader, although other readers such as a card reader or keypad for accepting a personal identification number (PIN) as the UID, etc., may also be used, as will be appreciated by those skilled in the art.

The authentication process may be as follows. Before the wireless communications device 21′ can use the authentication device 22′ for authentication purposes, the wireless communications device first establishes a secure PAN with the authentication device. To establish the secure PAN, the wireless communications device 21′ may be required to provide a fairly lengthy device identification code, for example, as will be appreciated by those skilled in the art. The optical transmitters 26r′, 26b′, 26g′ are well suited for transferring the device identification code to the authentication device 22′ as this saves the user the trouble of keying in a long code. Moreover, this is faster than manually keying in such a code, and it provides additional security since would-be hackers will not see the user typing in the code.

Before accessing a secure network, sending an email, etc., the user of the wireless communications device 21′ would first initiate an authentication sequence via a keypad or other input device (not shown) to establish the PAN with the authentication device 22′. The user then holds the housing 28′ adjacent the authentication device 22′ so that the optical transmitters 26r′, 26b′, 26g′ are generally aligned with corresponding red, blue, and green optical receivers 27r′, 27b′, 27g′ carried by the authentication device 22′. The processor 35′ causes the optical transmitters 26r′, 26b′, 26g′ to send optical signals to the authentication device 22′ which communicate the device identification code of the wireless communications device 21′. Moreover, the user also provides his UID, which in the present example is done by placing his finger 38′ on the fingerprint reader 36′.

Each of the red, blue, and green optical receivers 27r′, 27b′, 27g′ illustratively has a respective optical filter 37r′, 37b′, 37g′ associated therewith for filtering light other than the desired color, as will be appreciated by those skilled in the art. By way of example, the receiving area of the optical receivers 27r′, 27b′, 27g′ may be a few square millimeters (e.g., three). The optical receivers 27r′, 27b′, 27g′ may be photodiodes or other suitable light sensing devices, as will be appreciated by those skilled in the art. The transmission area of the optical transmitters 26r′, 26b′, 26g′ are preferably somewhat larger than the corresponding receiving areas, such as about a square centimeter. Of course, other dimensions may also be used.

The authentication device 22′ further illustratively includes a processor 39′ connected to the optical receivers 27r′, 27b′, 27g′, the identity reader 36′, a wireless PAN transceiver 40′, and a memory 41′. The processor 39′ compares the input received via the optical receivers 27r′, 27b′, 27g′ and the identity reader 36′ with corresponding entries stored in the memory 41′. If they match, the processor 39′ then cooperates with the wireless PAN transceiver 40′ to send an enabling signal via an accompanying antenna 42′ to the wireless PAN transceiver 23′ of the wireless communication device 21′, which enables the processor 35′ to perform the desired operation(s). Otherwise, a denial signal (or no signal at all) may be sent to the wireless communications device 21′ denying enablement thereof for the desired operation(s).

The authentication device 22′ may also have a secret key stored within the memory 41′ for use by the processor 39′ in initializing the PAN pairing process with the wireless communications device 21′, as will be appreciated by those skilled in the art. Once the devices 21′, 22′ have been successively paired in a PAN, it is no longer necessary to hold the two together as they may then communicate via the wireless PAN transceivers 40′, 23′ so long as the wireless communications device remains authenticated. The authentication device may further include a user notification device (not shown), such as an audio output transducer, a vibrator, and/or light emitting diode (LED), for example, to inform the user when the optical transmitters 26r′, 26b′, 26g′ and optical receivers 27r′, 27b′, 27g′ are aligned, whether the authentication procedure was successful or not, etc. Moreover, the authentication device 22′ may be a portable device also carried by the user, or it may be installed in a desired location, for example.

The authentication procedure may be changed for different applications. For example, in some applications it may be desirable to require the user of the wireless communications device 21′ to be authenticated each time access to a secure network is desired, or before sending each email. In other embodiments, periodic authentications may be more desirable, such as once a day when the wireless communications device 21′ is turned on, for example. Other authentication schedules or procedures may also be used, as will be appreciated by those skilled in the art.

To make sure that a would-be hacker who gains access to the previously authenticated wireless communications device 21′ cannot gain access to the device identification code, the code should preferably not be saved on either the wireless communications device or the authentication device 22′ in a form that is readily retrievable. That is, this code should not be stored in a “contacts” or “address” file that could be easily accessed by a would-be hacker. Moreover, the authentication device may delete the code after the pairing/authentication is complete, for example. For extra security, it may also be desirable to change the device identification code periodically (e.g., once a day).

The LCD 25′ has a refresh rate, which may be 60 Hz, for example, and the optical transmitters 26r′, 26b′, 26g′ operate based upon the refresh rate. That is, the pixels that make up the optical transmitters 26r′, 26b′, 26g′ cycle on and off at the given refresh rate of the LCD, which therefore sets the data transmission speed of the optical communications link between the wireless communications device 21′ and the authentication reader 22′, as will be appreciated by those skilled in the art.

It should be noted that the communications system 20′ is but one of many potential implementations of the present invention. In some embodiments, the optical communications link between the first and second units 21, 22 may be used for additional communications between devices, and not necessarily for authentication or enabling of other devices. Other examples of devices that may be used as the first and/or second units 21, 22 include printers, copiers or multi-function devices (MFDs), document scanners, cameras, barcode scanners, satellite navigation system (e.g., GPS/GALILEO) devices, etc. Moreover, the first and second units 21, 22 may communicate via a wireless LAN rather than a PAN, as discussed above.

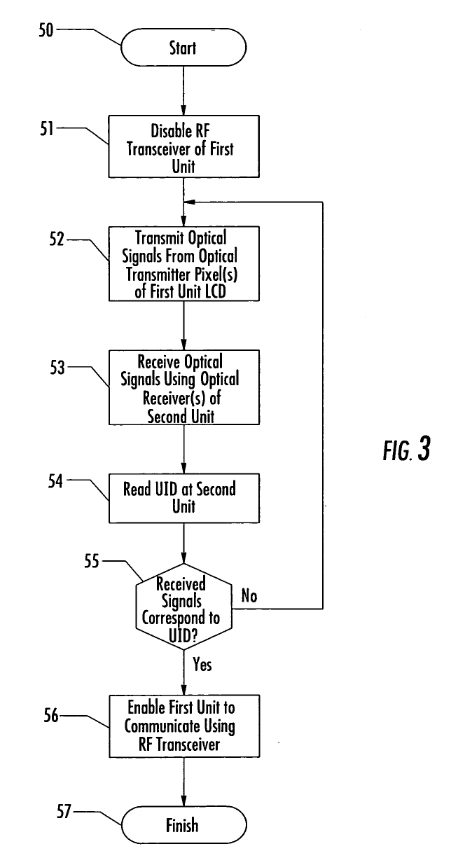

A communications method aspect of the invention is now described with reference to FIG. 3. Referring to the exemplary communications system 20′, beginning at Block 50 the wireless communications device 21′ is disabled for performing a given operation(s) in a starting state (e.g., when it is logged off a network or turned off), at Block 51. To authenticate the wireless communications device 21′, the user initiates an authentication process, holds the optical transmitters 26r′, 26b′, 26g′ adjacent the optical receivers 27r′, 27b′, 27g′ and places his finger on the identity reader 36′, as discussed above. The device identification code is via optical signals from the optical transmitters 26r′, 26b′, 26g′ and received by the optical receivers 27r′, 27b′, 27g′, at Block 52-53, and the UID (i.e., a fingerprint in the present example) is read by the identity reader 36′, at Block 54.

The processor 39′ of the authentication device 22′ then compares the UID and the received device identification code with corresponding information stored in the memory 41′, at Block 55. If they match, then the processor 39′ cooperates with the LAN/PAN transceiver 40′ to enable the wireless communications device 21′ for the desired operation(s), at Block 56, as discussed further above, thus concluding the illustrated method (Block 57). Otherwise, the authentication procedure may be repeated to provide the proper UID for the wireless communications device 21′.

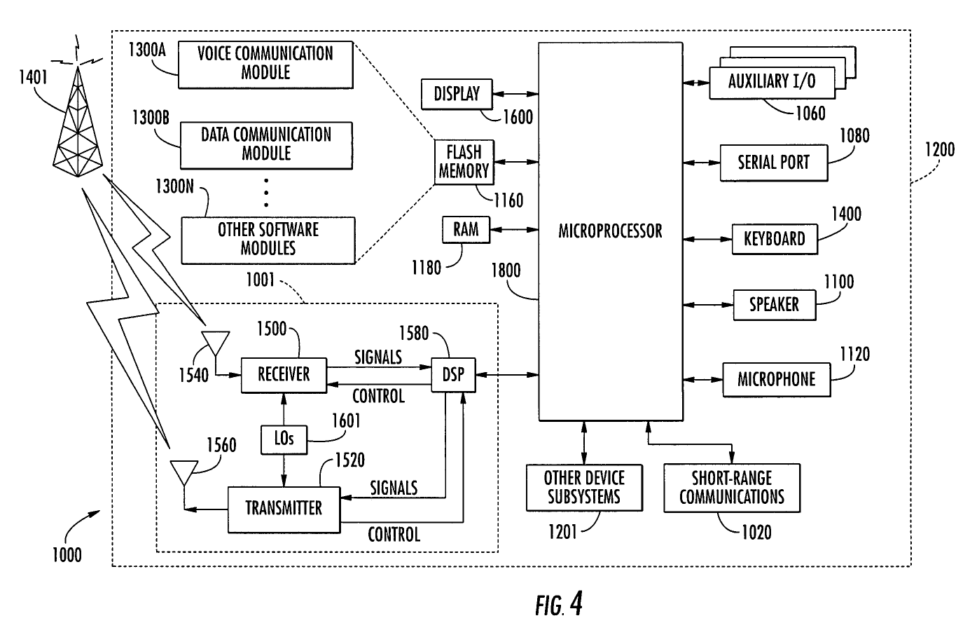

An exemplary device which may be used in accordance with the present invention is a handheld mobile wireless communications device 1000 now described with reference to FIG. 4. The device 1000 includes a housing 1200, a keyboard 1400 and an output device 1600. The output device shown is a display 1600, which is preferably a full graphic LCD. Other types of output devices may alternatively be utilized. A processing device 1800 is contained within the housing 1200 and is coupled between the keyboard 1400 and the display 1600. The processing device 1800 controls the operation of the display 1600, as well as the overall operation of the mobile device 1000, in response to actuation of keys on the keyboard 1400 by the user.

The housing 1200 may be elongated vertically, or may take on other sizes and shapes (including clamshell housing structures). The keyboard may include a mode selection key, or other hardware or software for switching between text entry and telephony entry.

In addition to the processing device 1800, other parts of the mobile device 1000 are shown schematically in FIG. 4. These include a communications subsystem 1001; a short-range communications subsystem 1020; the keyboard 1400 and the display 1600, along with other input/output devices 1060, 1080, 1100 and 1120; as well as memory devices 1160, 1180 and various other device subsystems 1201. The mobile device 1000 is preferably a two-way RF communications device having voice and data communications capabilities. In addition, the mobile device 1000 preferably has the capability to communicate with other computer systems via the Internet.

Operating system software executed by the processing device 1800 is preferably stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM)

1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM is preferably capable of organizing and managing data items, such as e-mail, calendar events, voice mails, appointments, and task items. The PIM application is also preferably capable of sending and receiving data items via a wireless network 1401. Preferably, the PIM data items are seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, PCS, GSM, etc. Other types of data and voice networks, both separate and integrated, may also be utilized with the mobile device 1000.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore requires a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keyboard 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth communications module to provide for communication with similarly-enabled systems and devices.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A communications system comprising:
first and second separate units at least one of which comprises a radio frequency (RF) transceiver;
said first unit comprising a liquid crystal display (LCD) including at least one optical transmitter pixel;
said second wireless unit comprising at least one optical receiver for receiving optical signals from said at least one optical transmitter pixel of said LCD.

2. The communications system of claim 1 wherein said at least one optical transmitter pixel comprises a plurality thereof.

3. The communications system of claim 2 wherein said plurality of optical transmitter pixels comprise different color optical transmitter pixels.

4. The communications system of claim 3 wherein said plurality of different color LCD transmitters comprise red, blue and green optical transmitter pixels.

5. The communications system of claim 3 where said at least one optical receiver comprises a plurality of different color optical receivers for respective different colors.

6. The communications system of claim 2 wherein at least one of the plurality of optical transmitter pixels transmits optical clock signals.

7. The communications system of claim 1 wherein said first unit comprises an RF transceiver; and
wherein said second unit comprises an identity reader for enabling said first unit to communicate using said RF transceiver thereof based upon a received unique identifier.

8. The communications system of claim 1 wherein said LCD has a refresh rate, and wherein said at least one optical transmitter pixel operates based upon the refresh rate.

9. The communications system of claim 1 wherein said at least one optical receiver comprises at least one optical filter.

10. The communications system of claim 1 wherein said RF transceiver communicates using at least one of a wireless local and personal area network protocol.

11. The communications system of claim 1 wherein said first unit further comprises a processor connected to said at least one optical transmitter pixel.

12. The communications system of claim 1 wherein said first and second units comprise respective first and second portable housings.

13. A communications system comprising:
first and second separate units each comprising a respective radio frequency (RF) transceiver;
said first unit comprising a liquid crystal display (LCD) including a plurality of different color optical transmitter pixels;
said second wireless unit comprising a plurality of different color optical receivers for receiving optical signals from respective different color optical transmitter pixels of said LCD.

14. The communications system of claim 13 wherein at least one of said plurality of different color optical transmitter pixels transmits a clock signal.

15. The communications system of claim 13 wherein said LCD has a refresh rate, and wherein said plurality of different color optical transmitter pixels operate based upon the refresh rate.

16. The communications system of claim 13 wherein said at least one optical receiver comprises at least optical filter.

17. A communications method comprising:
providing first and second separate units at least one of which comprises a radio frequency (RF) transceiver;
transmitting optical signals from at least one optical transmitter pixel of a liquid crystal display (LCD) on the first unit;
receiving the optical signals from the at least one optical transmitter pixel of the LCD using at least one optical receiver on the second unit.

18. The method of claim 17 wherein the at least one optical transmitter pixel comprises a plurality thereof.

19. The method of claim 18 wherein the plurality of optical transmitter pixels comprise different color optical transmitter pixels.

20. The method of claim 19 where the at least one optical receiver comprises a plurality of different color optical receivers for respective different color optical transmitter pixels.

21. The method of claim 18 wherein transmitting comprises transmitting optical clock signals from at least one of the plurality of optical transmitter pixels.

22. The method of claim 17 wherein transmitting comprises operating the at least one optical transmitter pixel based upon a refresh rate.

23. The method of claim 17 wherein the first unit comprises an RF transceiver and wherein the second unit comprises an identity reader; and further comprising using the identity reader for reading a unique identifier and enabling the first unit to communicate using the RF transceiver thereof based thereon.
